(19) United States
(12) Patent Application Publication
(10) Pub. No.: US 2013/0152317 A1
(43) Pub. Date: Jun. 20, 2013

(54) FILTER CARTRIDGE MOUNTING ASSEMBLY FOR ROBOTIC POOL AND TANK CLEANER

(71) Applicant: Aqua Products, Inc., Cedar Grove, NJ (US)

(72) Inventors: Giora ERLICH, North Caldwell, NJ (US); Seth CHILTON, West Orange, NJ (US)

(73) Assignee: AQUA PRODUCTS, INC., Cedar Grove, NJ (US)

(21) Appl. No.: 13/693,141

(22) Filed: Dec. 4, 2012

Related U.S. Application Data
(60) Provisional application No. 61/576,612, filed on Dec. 16, 2011.

(51) Int. Cl. B08B 9/08

(52) U.S. Cl. CPC B08B 9/08
USPC 15/1.7

(57) ABSTRACT

A self-propelled cleaning apparatus for cleaning a pool includes a housing cover removably fastened to a base to define an interior chamber and rotational supports coupled to the apparatus for moving it over submerged pool surfaces. A water discharge assembly with a water outlet for recirculating filtered water into the pool is coupled to the interior surface of the housing cover. A filter assembly for filtering water and debris flowing from the pool through a water inlet in the base is supported within the interior chamber above the base. A mounting bracket coupled to the water discharge assembly is configured to fixedly position and independently suspend the filter assembly within the interior chamber below the interior surface of the housing cover and above the interior surface of the base.

### CROSS-REFERENCE TO RELATED APPLICATION

This patent application claims the benefit of U.S. Provisional Application No. 61/576,612, filed Dec. 11, 2011, the content of which is incorporated by reference herein in its entirety.

### FIELD OF THE INVENTION

The present invention relates to a submersible robotic pool and tank cleaning apparatus, and more specifically to the installation, operation and maintenance of an internal filtering device within the cleaning apparatus for separating and isolating undesirable contaminants and debris from the pool or tank environment.

### BACKGROUND OF THE INVENTION

Robotic pool cleaning devices are mounted on rotatable supports, such as wheels, brushes and/or tracks, and are propelled or otherwise travel along submerged surfaces of a pool, tank or the like and, through the use of suction, thereby “vacuum” the pool surfaces over which they pass. The pool cleaning devices can be propelled over the surfaces of the pool by a directional or random water jet propulsion system, or by one or more drive motors that are coupled to (e.g., to the wheel axles) and cause the rotation of the rotatable supports.

The cleaning devices configured with an internal filtering system have an interior chamber with one or more filters mounted therein. The internal filtering systems are effective to capture and isolate contaminants and/or debris from portions of the interior chamber where it is highly desirable that contamination not encroach. The filtered water is then discharged back into the pool or tank as a pressurized stream.

The filter can be fabricated from a mesh material that is sewn into a configuration that is stretched over and/or held in place over a supporting open framework that is securely positioned inside the cleaning body or housing. Alternatively, rigid filter cartridges can be used in which the filter medium is a pleated web and which can also include an open mesh wire or plastic support to reduce collapsing of the finer pleated filter material. Filter cartridges are commonly cylindrical and include a separate flexible seal in the form of a ring that is fitted over the circular openings at each end.

Japanese Patent No. JP06-225847 to Sanden Corporation discloses a robotic pool cleaner having an internal water pump (i.e., a propeller or impeller) rotatably coupled to an electric motor via a shaft, and a rigid filter cartridge extending vertically between the interior surface of the base plate and the underside of the housing cover. The filter has an open bottom end positioned over a water inlet and a hinged filter lid that is formed in the housing cover and positioned over the open top end of the filter. Filter maintenance is performed by opening the hinged filter lid positioned directly over the top end of the filter, removing the filter, cleaning the filter and then reversing the steps to reinstall the filter. Once the filter is installed, the bottom and top ends of the filter contact and form a seal with the interior surface of the base plate circumscribing the water inlet and the underside of the hinged filter lid, respectively. The water pump creates a low pressure environment within the interior of the cleaner such that water is drawn through the water inlet formed and into the interior of the filter, and the drawn water passes through the filter body into the interior chamber and is discharged by the pump through a discharge outlet formed in the housing above the water pump. Any debris or contaminants that are drawn into the cleaner are trapped in the interior portion of the filter and prevented from being recycled back into the pool or tank.

Although the hinged filter lid enables easy access to the filter to enable cleaning or replacement, cleaning and maintenance of the filter can be frequently required, which is undesirable. Specifically, since the contaminated water flows directly into the interior of the filter from the water inlet, the interior of the filter and can quickly fill with debris which clogs the mesh or screen material which forms the filter body. Therefore, the filter must be cleaned on a more frequent basis.

In U.S. Pat. No. 6,473,927 to Sommer a robotic pool cleaner is disclosed having an internal filter cartridge circumscribing the water pump. Similar to the JP '847 patent, the water pump creates a low pressure environment within the interior of the cleaner such that water is drawn through one or more water inlets formed in the base plate of the cleaner. The water inlet(s) are positioned such that the incoming water and debris enters the housing's interior chamber surrounding the filter and flows through the filter body into the interior of the filter, and the filtered water is discharged by the pump through a discharge outlet formed in the housing above the pump. The filter cartridge has a height such that it extends to and fauns a seal with both the interior surface of the base plate and the underside of the housing cover in a filter cartridge capture arrangement.

More specifically, the filter cartridge lies sealingly on the bottom surface of the inner chamber and the underside of the cover. The top and bottom edges or ends of the cylindrical filter are in contact and form a seal with the underside of the housing cover and the bottom surface of the base plate, respectively. As a result, the cylindrical filter serves as a partition such that the exterior portion of the filter forms a contamination-exposed part of the inner chamber, while the interior portion of the filter forms a clean portion or zone of the inner chamber. The contamination-exposed part collects the debris and other contaminants from the water, and the filtered water in the clean portion is discharged through the discharge outlet for recirculation in the pool or tank.

During maintenance of the cleaner of the '927 patent, the user must remove the housing cover to access the filter to clean it or to replace it with a new filter. Reassembly of the cleaner with the cleaned or new filter requires that the user be able to properly align the housing cover such that both the top and bottom ends of the filter contact and seal against the underside of the housing cover and interior surface of the base plate, respectively. Disadvantageously, the user must blindly attempt to achieve this alignment without dislodging the bottom end of the filter from its desired position against the interior surface of the base plate. Because the pump motor is attached to the housing cover, a user must attempt to complete this reassembly, but the user is blind to the positioning. As a consequence, such blind assembly makes reassembly a very difficult task since misalignment and improper seating of the filter can result in a crimped or damaged the filter. The misaligned or damaged filter could allow debris to enter directly into the interior of the filter that normally contains only filtered water, and such debris could damage the pump propeller.

Another disadvantage of the cleaner of the '927 patent is that the housing is fabricated from a plastic material which can flex upwards and downwards, respectively, when the pump starts and stops. This vertical movement can dislocate or displace the contact seals between the underside of the housing cover and the interior surface of the base plate, and thereby allow debris to undesirably enter the interior portion of the filter and damage the pump propeller.

### SUMMARY OF THE INVENTION

The above problems and disadvantages are solved and avoided by the embodiments of the apparatus and methods of the present invention that are described below. In the description that follows, it will be understood that the cleaner moves on supporting wheels, brushes, rollers or tracks that are aligned with the longitudinal axis of the cleaner body when it moves in a straight line. References to the front or forward end of the cleaner will be relative to its then-direction of movement.

The present invention is directed to various embodiments of filter assemblies installed within the interior chamber of the automated pool or tank cleaner. As described in greater detail below, the filter assembly includes a filter body that is positioned between opposing filter covers which seal the top and bottom ends of the filter body. The filter assembly is securely, but removably mounted to the underside of the housing cover by fixedly suspending the filter assembly below the underside of the housing cover and above the interior bottom surface of the base. The filter assembly is independently suspended from the underside of the housing cover, and without the bottom portion of the filter assembly contacting or otherwise being supported therebelow by or from the interior surface of the base (underside) of the cleaning apparatus.

In general, a self-propelled robotic cleaning apparatus for cleaning a submerged surface of a pool or tank can include a housing having a front portion, an opposing rear portion and adjoining side portions defining the periphery of the apparatus. A base plate having an interior surface with at least one water inlet is mounted to the lower portion of the housing. Rotationally-mounted supports are coupled to the housing to move the cleaning apparatus along a cleaning path. A water pump is mounted in the interior of the housing. The water pump is configured to draw water and debris from the pool or tank through the at least one water inlet for filtering and discharge filtered water through at least one water discharge outlet. The internal water pump provides a pressurized water jet that is expelled from the water-discharge outlet to propel the cleaner in a forward or reverse direction. Alternatively, the water pump can be remote from the cleaner and connected by a hose. In this latter embodiment, one or more drive motors are provided to rotate the rotationally-mounted supports to move the cleaner in a forward and rearward directional path.

In one embodiment, a self-propelled robotic cleaning apparatus for cleaning a submerged surface of a pool or tank comprises a housing having a cover and a base, the base having an interior surface defining at least one water inlet, the housing cover removably fastened to the base to define an interior chamber; rotationally-mounted supports coupled to the housing for moving the apparatus over the submerged surface of the pool or tank through a corresponding outlet in the housing cover; a water discharge assembly coupled to an interior surface of the housing cover and having a discharge outlet for recirculating filtered water into the pool or tank; a filter assembly positioned within the interior chamber for filtering water and debris flowing from the pool or tank through the at least one water inlet, the filter assembly including a filter body having top end and a bottom end; and a mounting bracket coupled to the water discharge assembly and configured to fixedly position and independently suspend the filter assembly within the interior chamber below the interior surface of the housing cover and above the interior surface of the base.

In one aspect, the mounting bracket extends from a lower end of the water discharge assembly. The mounting bracket can be mounted to an outwardly extending flange formed at the lower end of the water discharge assembly, although such configuration is not limiting. In another aspect, the mounting bracket includes an upper filter cover configured to receive and sealingly contact the periphery of the top end of the filter body. The upper cover mates or makes contact to seal to open end of the filter to prevent unfiltered water and debris from being drawn into the water discharge assembly.

In yet another aspect, the filter assembly further includes an upper filter cover configured to receive at least a portion of the top end of the filter body in sealing contact. The upper filter cover can be configured to circumscribe a lower end of the water discharge assembly, although such configuration is not limiting.

In one embodiment, the water discharge assembly comprises a directional water jet propulsion valve assembly mounted to the interior surface of the housing cover. In another embodiment, the water discharge assembly comprises a discharge conduit extending upwardly and is mounted to the interior surface of the housing cover.

As will be understood by those of ordinary skill in the art, the open ends of the cartridge filter body can be fitted with annular seals of resilient material that are provided with a groove that snugly receives the pleated filter and prevents water from by-passing the filter medium.

In one aspect, the filter assembly includes a lower filter cover positioned adjacent the bottom end of the filter body. The lower filter cover is configured to sealingly receive at least a portion of the bottom end of the filter body that is fitted with the annular resilient seal or gasket and the filter body is thereby secured between the upper and lower filter covers. Preferably, a gasket is adhered to or otherwise secured to each end (i.e., top end and the bottom end) of the filter body. The lower filter cover can be releasably coupled to the mounting bracket.

In one embodiment, the cleaning apparatus further comprises means to generate a low pressure environment in the interior chamber to draw water and debris from the pool or tank through the at least one water inlet for filtering and discharging filtered water through the discharge assembly. In one aspect, the means to generate a low pressure environment is a water pump positioned externally from the apparatus and in fluid communication with the discharge outlet via a buoyant flexible conduit. Alternatively, the means to generate a low pressure environment is a water pump attached to the mounting bracket, wherein the water pump is suspended within the interior chamber below the interior surface of the housing cover and above an interior surface of the base.

In one embodiment, the filter body is axially aligned with and circumscribes the internal water pump. The lower filter cover is positioned below and secured to the water pump, and the lower filter cover can be secured to the water pump with a fastener. In one aspect, the filter body is cylindrical, although such shape is not limiting. Regardless of its cross-section, the filter body is provided with corresponding resilient seals that engage the ends of the filter medium, and any supporting materials that is provided, in order to provide a substantially fluid-tight seal with the upper and lower covers.

In still another aspect, the filter assembly further comprises an elongated curvilinear resilient member, or spiral element, that is positioned within an interior portion of the filter body and which extends between the bottom and top ends of the filter body. The resilient member is preferably configured to assume the curvature of the interior surface of the wall of the filter body. Alternatively, the filter assembly can include a resilient element positioned within an interior portion of the filter body and which extends from lower filter cover to the top end of the filter body. The resilient member contacts and supports the interior of the filter body during operation of the water pump. More specifically, the resilient element is configured and dimensioned to follow the interior surface of the filter body and to support the surface against any radial forces that develop during use that may tend to collapse or deform the filter material. Such forces can develop as the filter medium accumulates dirt particles and the pressure drop across the filter increases to exceed the ability of the filter to maintain its original shape.

In another embodiment, a self-propelled robotic cleaning apparatus for cleaning a submerged surface of a pool or tank comprises: a housing having a cover and a base with at least one water inlet, the housing cover being removably fastened to the base to define an interior chamber; rotationally-mounted supports coupled to the housing for moving the apparatus over the submerged surface of the pool or tank; a water discharge assembly coupled to an interior surface of the housing cover and having a discharge outlet for recirculating filtered water into the pool or tank; a mounting bracket coupled to a lower portion of the water discharge assembly; a water pump for drawing water and debris from the pool or tank through the at least one water inlet, the pump being supported by the mounting bracket and suspended within the interior chamber below the interior surface of the housing cover and above an interior surface of the base; and a filter assembly circumscribing the water pump for filtering the water and debris drawn into the interior chamber, the filter assembly being fixedly positioned and suspended below the interior surface of the housing cover and above and spaced apart from an interior surface of the base.

In one aspect, the filter assembly further includes a filter body having a top end gasket and a bottom end gasket, an upper filter cover positioned adjacent the top end gasket of the filter body and a lower filter cover positioned adjacent the bottom end gasket of the filter body. In another aspect, the upper filter cover is mounted to the mounting bracket and the lower filter cover is removably secured to a lower portion of the water pump. In still another aspect, the water discharge assembly is a water jet valve assembly for discharging a directional water jet to propel the apparatus in a predetermined direction, and the water pump is vertically aligned with the water jet valve assembly and includes a propeller (or impeller) that is rotatable by an electric motor via a rotatable shaft, the propeller being positioned within a lower portion of the water jet valve assembly.

### BRIEF DESCRIPTION OF THE DRAWINGS

The invention will be described in further detail below and with reference to the attached drawings in which:

FIG. 1 is a top, left side perspective view of a first embodiment of a self-propelled robotic pool or tank cleaner illustrating a filter assembly of the present invention;

FIG. 2 is a cross-sectional view the pool cleaner taken along line 2-2 of FIG. 1 illustrating the filter assembly mounted in a suspended position within an interior chamber of the cleaner of FIG. 1;

FIG. 3 is an elevated, partial cross-sectional view of the pool cleaner of FIG. 1 illustrating the housing cover being removed from the base;

FIG. 4 is an elevated, partial cross-sectional view of the housing cover turned upside down and illustrating the removal of the filter assembly from the underside of the housing cover;

FIG. 5 is a side elevated view of the filter assembly of the pool cleaner of FIG. 1;

FIGS. 6A-6D are perspective, front, side and top views, respectively, of a filter expansion spring suitable for use with the filter assembly shown in FIG. 5;

FIG. 7 is a top, left side perspective view of a second embodiment of a self-propelled robotic pool or tank cleaner illustrating the filter assembly of the present invention;

FIG. 8 is a cross-sectional view the pool cleaner taken along line 8-8 of FIG. 7 illustrating the filter assembly mounted in a suspended position within an interior chamber of the cleaner of FIG. 7.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DESCRIPTION OF THE PREFERRED EMBODIMENTS

For purposes of providing a better understanding the invention, terms connoting direction and positioning of components are defined as follows:
longitudinal axis of the cleaner is defined as extending centrally through the cleaner in the direction of movement;

movement of the cleaner in a forward direction is the direction that the cleaner is presently being propelled or driven along its cleaning path;

movement of the cleaner in a reverse direction is a direction that is opposite to the forward direction along the cleaning path;

the front of the cleaner is defined as the portion of the cleaner extending perpendicular along the longitudinal axis in the forward direction of movement as the cleaner travels along its cleaning path;

“top”, “bottom”, “upper” and “lower” are adjectives that denote different cleaner components, as well as define the relative positioning of such components with respect to a central vertical axis extending centrally through the housing cover and base of the cleaner.

“base plate” is broadly interpreted as one or more components forming or otherwise defining an underside of the housing and which is positioned substantially parallel to the surface of the pool or tank which is being cleaned.

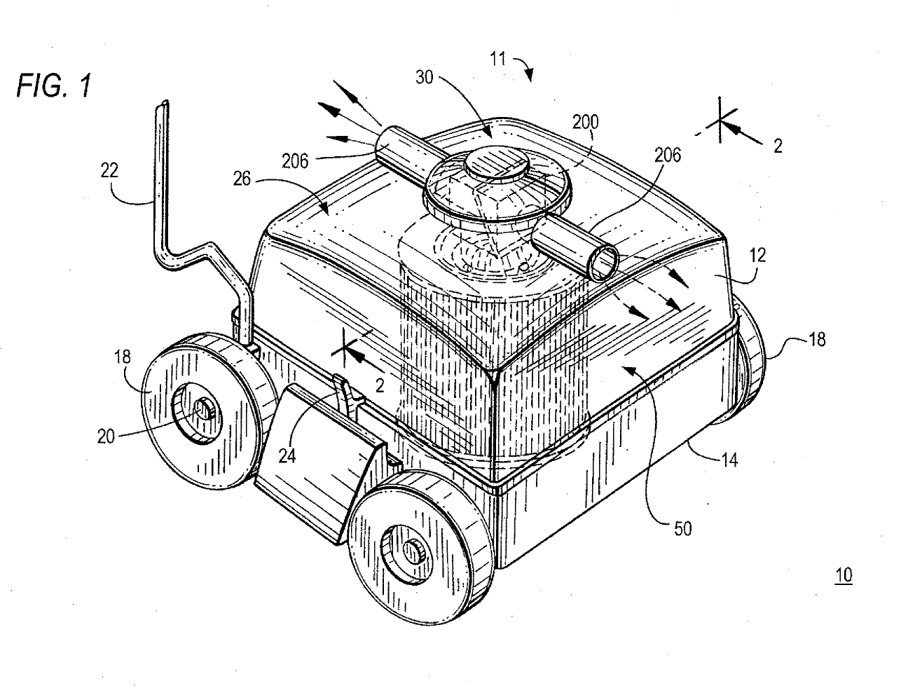

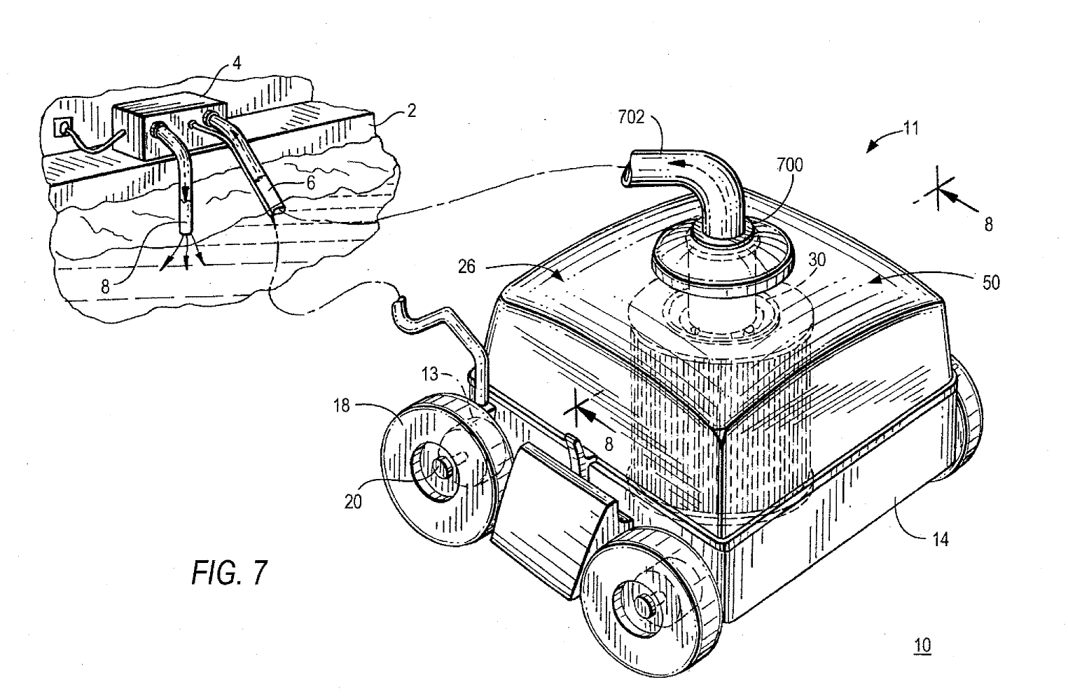

Referring generally to FIGS. 1 and 7, first and second embodiments of a self-propelled robotic pool or tank cleaner 10 illustrating a filter assembly 50 of the present invention are illustratively shown. In both embodiments, the pool cleaner 10 comprises a housing 11 having a cover 12 and a base 14 with at least one water inlet formed in the bottom surface of the base 14. The housing cover 12 is removably fastened over the base 14 to define an interior chamber 26. The housing cover 12 and base are removably fastened with one or more fasteners 24, such as a clasp, latch, spring clip, bolt or other well-known and conventional fastener. A gasket or other seal (not shown) can be inserted between the base 14 and cover 12 to prevent water flowing therebetween into and out of the interior chamber 26. The housing cover 12 and base 14 are preferably made of a plastic-like material, such as polyvinylchloride (PVC), polypropylene, among other well-known thermoplastic materials, aluminum and/or alloys thereof, and/or combinations thereof, and/or other water impermeable materials.

Rotationally-mounted supports 18 are coupled to the housing 11 for moving the cleaner 10 over the submerged surface of the pool or tank 2. As shown in FIGS. 1 and 7, the rotationally-mounted supports 18 are wheels mounted on axles 20. Alternatively, the Rotationally-mounted supports 18 can be or include one or more tracks. As shown in FIG. 7, the cleaner 10 is propelled by one or more drive motors 13 which engage and rotate one or more of the wheels 18 in a well-known manner.

In either embodiment, control means (not shown) are provided to periodically reverse the direction of movement to assure that the cleaner does not become immobilized, e.g., by an obstacle in the pool. If, for example, the pool cleaner does not change its orientation with respect to the bottom or sidewall as indicated by a signal from an on-board sensor (e.g., mercury switch) indicating that such transition has occurred during the prescribed period, e.g., three minutes, a control circuit will automatically change the direction of the drive means (i.e., drive motors or water jet propulsion valve assembly) in order to permit the cleaner to move away from the obstacle and resume its scanning pattern. Sensors, such as magnetic and infrared-responsive signaling devices can also be provided to change the direction of movement in response to prescribed conditions, e.g., absence of forward movement due to an obstacle. In addition, the control means can automatically steer the cleaner to the right or left while moving in either the forward or reverse direction. Power for the cleaner 10 is supplied by a buoyant electrical cable 22 attached to an external power source, such as a transformer or a remote battery contained in a floating housing at the surface of the pool 2, although such power sources are not considered limiting.

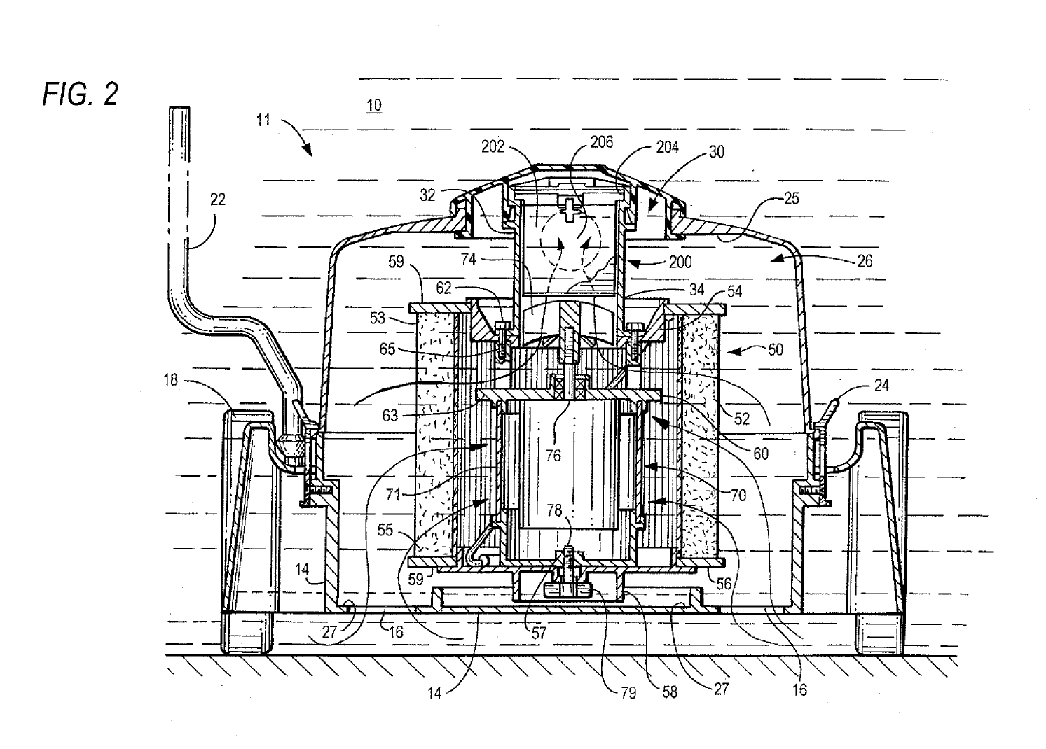

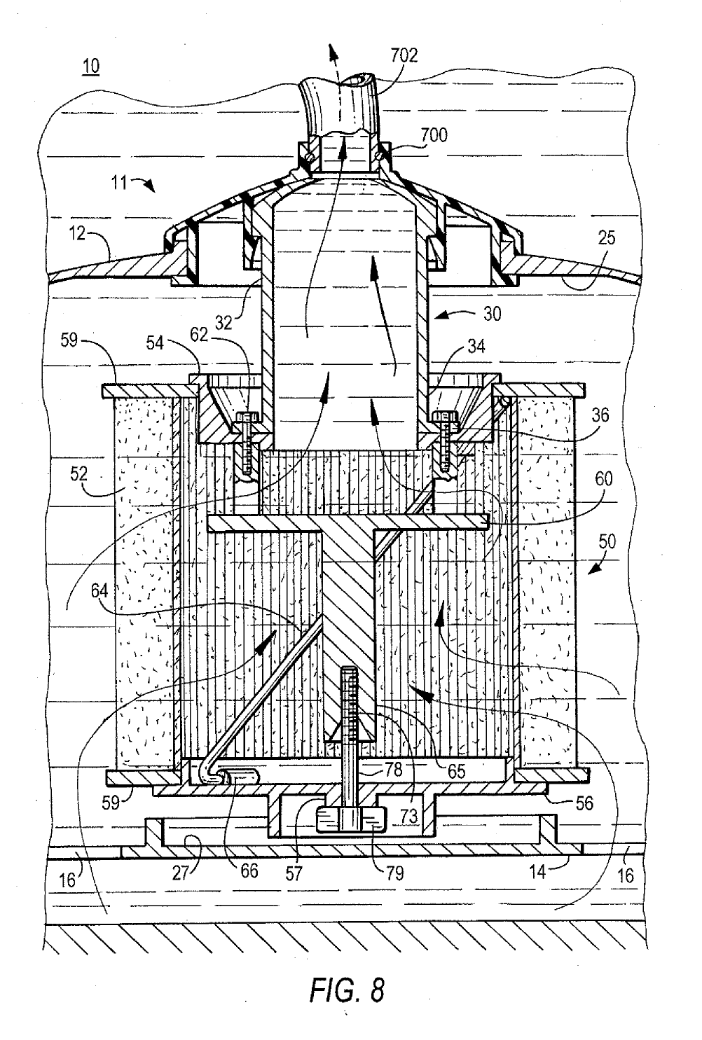

The embodiments of the cleaner 10 depicted in FIGS. 1 and 7 include at least one water inlet 16 (see FIGS. 2 and 8) formed through the bottom surface of the base 14, a filter assembly 50 positioned within the interior chamber 26 and a water discharge assembly 30 that is in fluid communication with a corresponding outlet in cover 12. In the first embodiment of FIG. 1, a water pump 70 is also provided within the interior chamber 26. Alternatively, in a second embodiment of FIG. 7, a water pump 4 is remotely located from the cleaner 10. In either embodiment, the water pump 70 or 4 creates a low presser environment in the interior chamber 26, which causes water and debris from the pool or tank 2 to be drawn through the at least one water inlet 16 into the interior chamber 26, flow through the filter assembly, and the filtered water is discharged by the water discharge assembly 30. The debris and/or other contaminants are separated from the intake water and isolated within the interior chamber 26 by the filter assembly 50, as described below in further detail with respect to FIGS. 2 and 8.

Referring now to FIG. 1, the water discharge assembly 30 is coupled at its upper end 32 to an interior surface (i.e., underside) 25 of the housing cover 12. An opposing lower end 34 of the water discharge assembly 30 is spaced distally below the underside 25 of the housing cover 12 within the interior chamber 26.

The water discharge assembly 30 includes a directional water jet valve propulsion assembly 200 which controls the direction of a pressurized water jet stream to propel the cleaner 10 in a forward direction, where the front of the cleaner 10 is defined as the direction in which the cleaner 10 is then moving.

As shown in FIG. 1, the jet valve 200 includes one or more discharge outlets 206 to discharge and recirculate filtered water from the cleaner, as well as form a pressurized water jet to propel the cleaner 10 in a forward or reverse direction. In one embodiment, the water is drawn from beneath the base 14 and passed through at least one filter medium to remove debris and is forced by a pump through a directional discharge conduit 206 which is aligned with the longitudinal axis of the pool cleaner. The resulting or reactive force of the discharged water jet propels the cleaner in the opposite direction. The water jet can be diverted by various means and/or divided into two or more streams that produce resultant force vectors that also affect the position and direction of movement of the cleaner. For a detailed understanding of a pool cleaner having a jet valve for producing a water jet to propel the cleaner in a forward and reverse direction, among other features of a pool cleaner suitable for implementing the steering assembly, the reader is directed to commonly assigned U.S. Pat. No. 7,900,308, issued Mar. 8, 2011, U.S. Pat. No. 7,827,643, issued Nov. 9, 2010, U.S. Pat, No. 7,165,284, issued Jan. 23, 2007, U.S. Pat. No. 6,742,613, issued Jun. 1, 2004 and U.S. Pat. No. 6,412,133, issued Jul. 2, 2002, the contents of which are incorporated herein by reference in their entirety. Accordingly, in the embodiment of FIG. 1, drive motor(s) 13 for rotating the wheels 18 (as shown in FIG. 7) are not required to move the cleaner 10 along the submerged surface of the pool or tank 2.

Referring to FIG. 7, a remote pump 4, e.g., positioned proximate the pool or tank 2, creates a low pressure environment within the interior chamber 26 to draw water through the at least one water inlet 16 from the pool or tank 2 into the interior chamber 26. The inlet water passes through the filter assembly 50 and the filtered water flows through a discharge outlet 700 and into the flexible conduit or hose 702 to the pump 4. The remote pump 4 recirculates the filtered water back into the pool or tank 2 via a pump outlet 8.

Referring now to FIG. 2, a filter assembly 50 is positioned within the interior chamber 26 formed below the underside 25 of the housing cover 12 and displaced above the bottom interior surface 27 of the base 14. The filter assembly 50 includes a filter body 52 having top end 53 and a bottom end 55, an upper filter cover 54 positioned adjacent the top end 53 of the filter body 52, and a lower filter cover 56 positioned adjacent the bottom end 55 of the filter body 52. The filter body 52 is preferably cylindrical in shape, although other filter body shapes are contemplated, such as rectangular, oval, and/or other combinations of shapes. The filter body 52 is preferably pleated or corrugated to increase surface area and is fabricated from an appropriate filter medium known to the art. A course filter for leaves, twigs, insects and the like in the form of a mesh material, such as wire, plastic and the like, that circumscribes an optional finer inner mesh material to initially filter larger particles and subsequently filter smaller particles, respectively, can also be provided. For example, the at least one of the upper and lower filter covers 54 and 56 can have a diameter or surface area that extends laterally a distance greater than the periphery of the filter body 52 to support a mesh-like structure therebetween and which circumscribes the exterior of the filter body 52 to repel, occlude and/or otherwise prevent larger particles and debris from compromising the filter body structure and/or blocking the water flow therethrough. In another aspect, the pleated portion of the filter body can also be formed with a supporting open-mesh material on the lower pressure side to prevent the collapse and/or deformation of the filter medium as the pressure drops increases. This reinforcing mesh will also prolong the cleaning cycle by allowing the filter to collect more debris.

Water from the pool or tank 2 that is drawn through the water inlets 16 flows into the interior chamber 52 between the external surface of the filter body 52 and the interior sidewalls of the base 14 and housing cover 12 which define an “unfiltered zone”. As the water flows through the filter body 52 into the interior area of the filter that defines a “filtered zone”, undesirable debris or particles are isolated and retained in the unfiltered zone, and the filtered water is subsequently discharged by the water discharge assembly 30 and recirculated into the pool or tank 2.

The filter body 52 is fixedly suspended below the underside 25 of the housing cover 12 and above and spaced apart from the bottom interior surface 27 of the base 14 by coupling the upper end of the filter assembly 50 to the lower end of the water discharge assembly 30. In the embodiment illustratively shown in FIG. 2, a mounting bracket 60 is provided to secure the upper end of the filter assembly 50 and the water pump 70 to the lower portion 34 of the water discharge assembly 30. The mounting bracket 60 includes an upper end 63 that circumscribes and is fixedly attached to an outwardly extending flange 36 via one or more fasteners 62, such as a bolt, latch, clip and the like. A lower end 65 of the mounting bracket 60 supports the water pump 70 therebelow. The structure for supporting the water pump, i.e., the motor and impeller/propeller, and the filter assembly can be of any suitable configuration. As will be understood by one of ordinary skill in the art, the support can be molded or cast, e.g., as an integral assembly with appropriate fittings, for attaching the water pump 70 and the upper filter cover 54.

The water pump 70 includes a waterproof pump housing 71 that contains an electric motor 72 that is coupled to a propeller or impeller 74 via a rotatable shaft 76. The water pump 70 is positioned vertically within the interior of the filter assembly 60 in a coaxial arrangement such that the electric motor 72 is positioned below the lower end 65 of the mounting bracket 60, the shaft extends through an opening in the mounting bracket 60, and the propeller 74 is positioned within the lower portion 34 of the water jet propulsion valve assembly 200. The pump housing 71 circumscribes and seals the electric motor 72 from the surrounding water environment, as well as secures the pump to the lower end 65 of the mounting bracket 60.

The top and bottom ends 53, 55 of the filter body 52 are each provided with a resilient gasket or seal, i.e., upper and lower gaskets 59. The gaskets 59 are fabricated from a soft, flexible water-impermeable material, such as synthetic rubber, plastic and the like. Preferably, the gaskets 59 are adhered to or otherwise bonded to the top and bottom ends 53, 55 of the filter body 52. The gaskets 59 overlap, enclose and protect the edges of the pleated fabric at the opposing ends of the filter body 52. A person of ordinary skill in the art will appreciate that the gaskets 59 can be integral (e.g., adhered to or otherwise bonded) with the filter body 52 or separate components of the filter assembly 50. The upper and lower filter covers 54 56 are illustratively circular in shape to conform to the shape of the top and bottom ends 53, 55 of the filter body 52. The top end 53 of the filter body 52 is positioned below the upper filter cover 54 and the bottom end 55 of the filter body 52 is positioned above the lower filter cover 56 such that the upper and lower gaskets 59 abut against and form a seal against at least a portion of the filter covers 54 and 56 to secure the filter body 52 therebetween.

The lower filter cover 56 abuts against at least a portion of the lower gasket 59 and/or bottom end 55 of the filter body 52 and is secured to the housing 71 of the water pump 70 by a fastener. As illustratively shown in FIG. 2, the lower filter cover 56 includes an aperture 57 configured to receive a bolt 78 that extends downward from the bottom surface of the water pump housing 71. A threaded nut, such as a wing nut 79 can be tightened manually to secure and seal the lower filter cover 56 against the bottom end of the filter body 52. Further, a collar 58 can extend downward from the bottom surface of the lower filter cover 56 to circumscribe the wing nut 79 and prevent debris from snagging or otherwise entangling with the fastener.

Advantageously, the seals formed by the filter body 52 (and/or gaskets 59) and both upper and lower filter covers 54 56 controls the flow of the water in the unfiltered zone of the interior chamber 26 such that it can only flow through the pleated sidewall material of the filter body 52. This helps to ensure that undesirable particles are isolated from the filtered zone and not recycled back into the pool or tank 2.

Moreover, the mounting bracket 60 helps ensure that the filter body 52 is fixedly suspended and secured below the underside 25 of the housing cover and above and separated from the bottom interior surface 27 of the base 14. Suspending the filter assembly 50 within the interior chamber 26 as illustratively shown in FIG. 2 helps reduce operational noises from the filter assembly 50 that would otherwise occur in event a component of the filter assembly 50 undesirably contacts any interior surface of the chamber 26. Additionally, crimping or otherwise deforming the filter body 52 can be detrimental to the cleaner 10 as debris can flow through the broken seals at the top and/or bottom ends of the filter body and into the filtered zone. Debris undesirably entering the filtered zone can damage the propeller (or impeller) that is rotating at high rotations per minute (rpm) as the water is discharged through the discharge assembly 30, thereby rendering the cleaner 10 inoperable, delaying cleaning of the pool or tank and requiring costly repairs. By spacing the filter assembly 50 away from the underside 25 of the housing cover and the bottom interior surface 27 of the base 14, possible deformation of the filter body 52 and breaking of the seals formed by the gaskets 59 is eliminated in the event that the flexible plastic housing cover 12 or base 14 deform vertically, for example, due to acceleration forces created by the motor during activation and deactivation of the water pump 70. In one embodiment, the lower surface (or collar 58) of the lower filter cover 56 is at least 3/16″ above the bottom interior surface 27 of the base 14 to maximize the surface area of the filter body 50, although such spacing is not considered limiting.

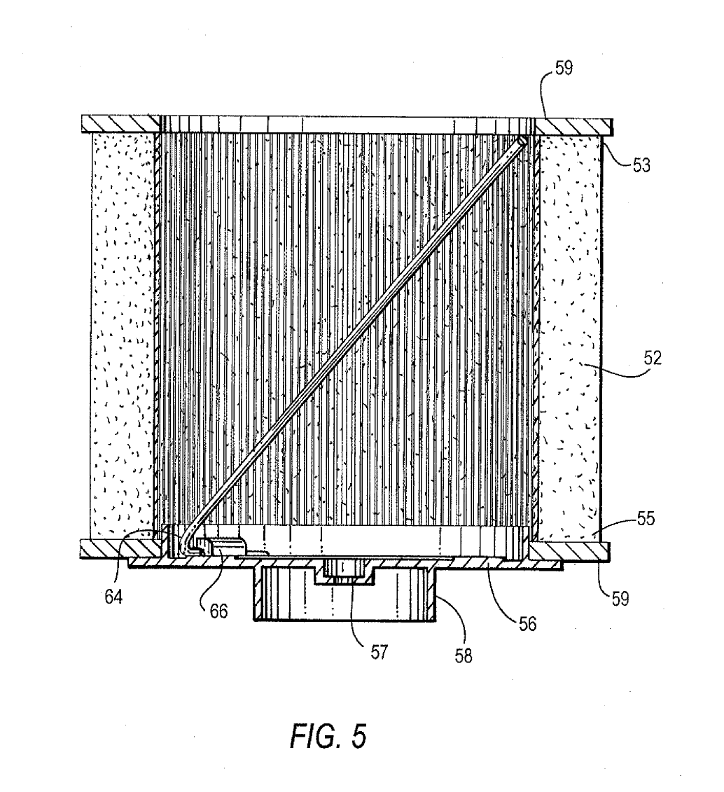

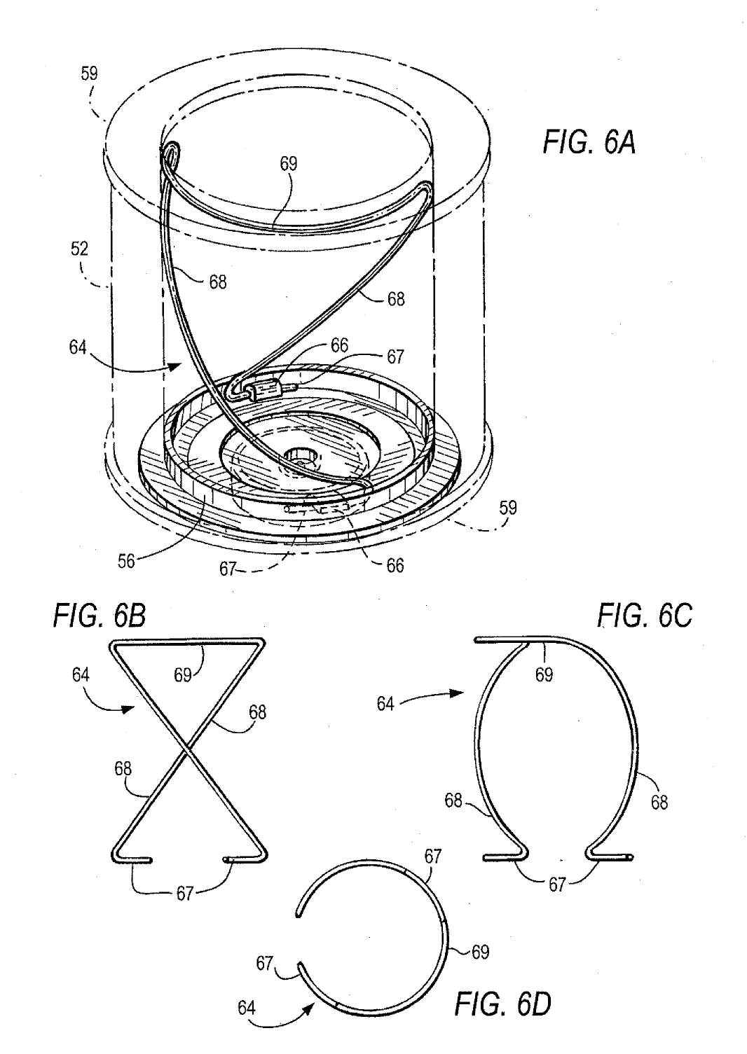

Referring now to FIGS. 5 and 6A-6D, a filter supporting member in the form of an elongated resilient member 64 is optionally provided within the interior portion of the filter to help maintain the structure of the filter body 52 in a fully expanded state. The illustrative resilient member 64 is curvilinear in shape and has opposing ends 67 that are fastened to the lower filter cover 56 by a fastener, such as a clasp, clip, through a bore, and/or other well-known spring fasteners and techniques. Referring to FIGS. 6A-6D, the resilient supporting member 64 can be formed from a rod or wire that includes an intermediate portion 69 having opposing lateral legs 68 that terminate at an end portion 67. Referring now to FIG. 6A, the filter supporting member 64 has a first end 67 fastened via a clasp 66 to the upper surface of the lower filter cover 56. A first lateral leg 68 extends from the first end 67 and slopes upwardly to a first end of the intermediate portion 69, which is positioned in a substantially horizontal plane with respect to the upper and lower filter covers 54 56, and has an arcuate shape that conforms to the circular shape of the upper interior surface of the filter body 52. In one embodiment, the intermediate portion 69 extends in a range of approximately 45 degrees to 270 degrees, and preferably 180 degrees along the upper interior surface of the filter body 52, although such range is not considered limiting. A second lateral leg 68 extends from the opposing end of the intermediate portion 69 and slopes downwardly to the second end 67, which is also fastened via a second clasp 66 provided on the upper surface of the lower filter cover 56. The two sloping curvilinear legs 68 are also curved to conform to the cylindrical interior shape of the filter body 52. The legs 68 are fastened approximately 180 degrees apart along the upper surface of the lower filter cover 56. In this manner, the legs 68 are curved around the water pump 70 while the filter supporting member 64 supports and consistently retains the filter body 52 in an upright and fully extended configuration, thereby preventing buckling in the vertical direction. A person of ordinary skill in the art will appreciate that in the event that other filter shapes are employed, the configuration of filter support member 64 can be modified to provide the desired support.

Referring now to FIGS. 7 and 8, the cleaner 10 is operable with a remote pump 4 to create a low pressure zone or environment within the interior chamber 26, and one or more drive motors 13 are operationally coupled to the rotational supports 18 to propel the cleaner in a forward or reverse direction. The water discharge assembly 30 of this alternative embodiment is a conduit having an upper portion 32 that is fastened to and extends vertically downward from the underside 25 of the housing cover 12. The discharge assembly 30 is preferably cylindrical in shape, although such shape is not considered limiting. Moreover, the upper portion 32 of the discharge outlet 700 can be secured to the underside 25 of the housing by one or more fasteners such as a bolt, clasp, snap-fit, and the like.

The mounting bracket 60 is attached at its upper end 63 to the outwardly extending flange 36 formed at the lower portion 34 of the discharge outlet 30 by one or more fasteners 62, as described above with respect to the embodiment shown in FIGS. 1 and 2. As shown in FIG. 7 (and FIG. 1) the upper filter cover 54 circumscribes the lower portion 34 of the discharge assembly 30 and is secured between the lower portion 34 of the discharge assembly 30 and upper end 63 of the mounting bracket 60. Although the mounting bracket 60, lower portion 34 (e.g., flange 36) of the discharge assembly 30 and/or the upper filter cover 54 are shown as three independent components, a person of ordinary skill in the art will appreciate that the three assembled components can be fabricated as a combination of two or more integrally formed components. For example, the mounting bracket 60 can be integrally formed with at least one of the upper filter cover 54 or the lower portion 34 of the water discharge assembly 30. Similarly, the upper filter cover 54 can be integrally formed with at least one of the mounting bracket 60 or the lower portion 34 of the water discharge assembly 30.

The filter assembly 50 is positioned below water discharge assembly 30 in the same manner as described with respect to the embodiment of FIG. 1, except that the lower filter cover 56 is fastened to the lower end 65 of the mounting bracket 60, instead of to the bottom portion of the pump housing 71 of FIG. 1. As illustratively shown in FIG. 7, the lower end 65 of the mounting bracket 60 extends vertically downward along a central axis of the filter assembly 50. The lower end 65 can extends vertically downward proximate to, and preferably does not contact the upper surface of the lower filter cover 56. By maintaining a space between the lower end 65 of the mounting bracket 60 and the lower filter cover 56, a margin of clearance is provided therebetween to prevent noise and deformation in the event vertical vibrations are present.

The lower end 65 of the mounting bracket 60 includes a threaded bore 73 sized and configured to receive the bolt 78, which is used to secure and fasten the lower cover plate 56 to bottom portion of the filter body 52. Preferably, a carriage bolt is used to secure the lower filter cover 56 to the mounting bracket 60. In one embodiment, the bolt head is a wing nut 79 and a portion of the bolt shaft proximate the wing nut 79 is unthreaded so that it freely passes through the aperture 57 formed in the lower filter cover 56. The opposing end of the bolt 78 is threaded and secured within the bore 73 by manually turning the wing nut 78. Although the bolt 78 secures the lower filter cover to the underside of the filter body 52, the unthreaded portion of the bolt 78 allows the lower filter cover 56 to move slightly up and down from vibrations without the lower filter cover 56 or mounting bracket 60 incurring any stress fractures.

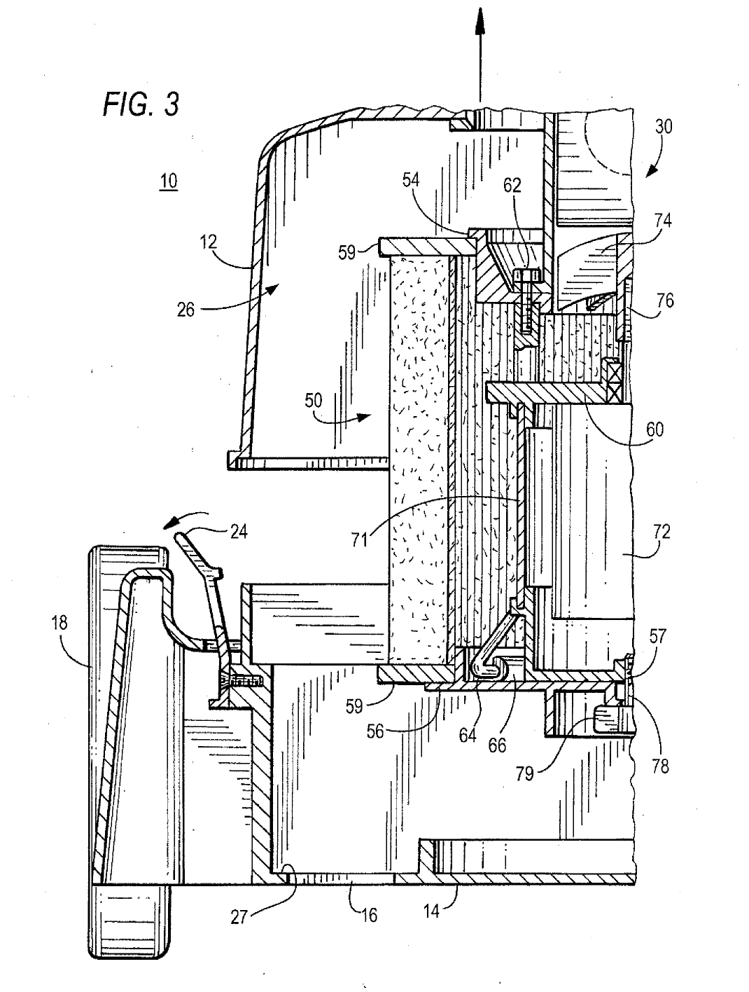

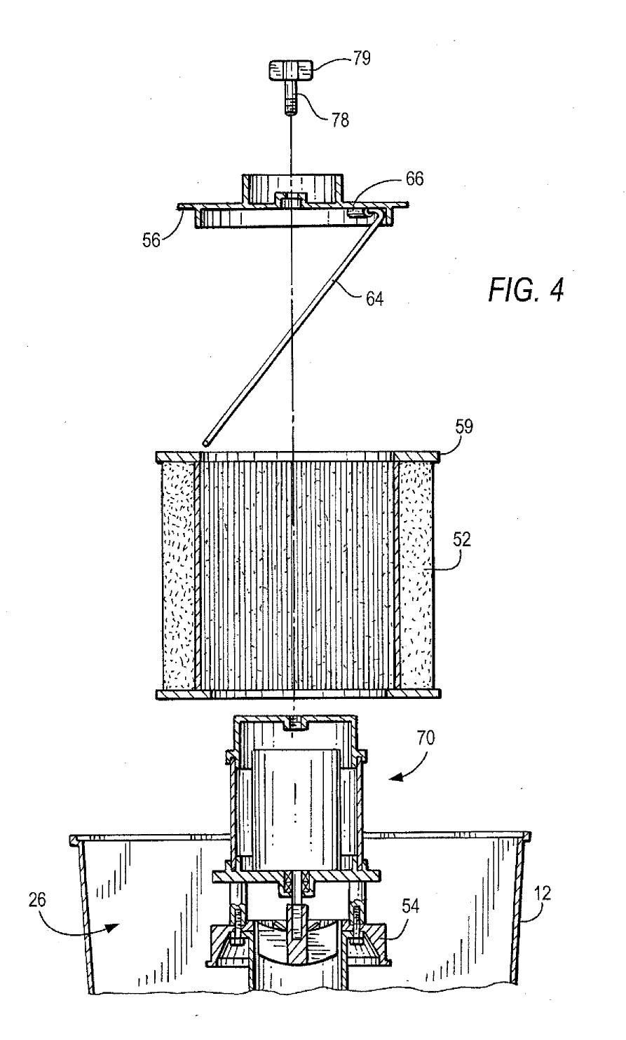

Referring now to FIGS. 3 and 4, installation and/or replacement of the filter assembly 50 are illustratively shown. Referring to FIG. 3, the housing cover fasteners 24 (e.g., latch, clasp or other fasteners) are opened or otherwise disengaged to allow a user to vertically lift the housing cover 12 off from the base 14. When the housing cover 12 is vertically lifted, the filter assembly 50 (and water pump 70 for the embodiment of FIG. 1) is lifted with the housing cover 12. Once the base 14 is cleared, the housing cover 12 with the attached filter assembly 50 is flipped upside down, as illustratively shown in FIG. 4, and placed on the ground or on another suitable supporting service during maintenance.

Referring now to FIG. 4, the housing cover 12 is shown in an upside down position with respect to the supporting surface. The procedure to remove the filter assembly 50 includes manually removing the lower filter cover 56 from the bottom end 55 of the filter body 52 by disengaging the lower filter cover fastener. For example, in the embodiment of FIG. 1, the wing nut 79 is rotated to disengage from the bolt 78 extending from the bottom surface of the pump housing 71. Alternatively, in the embodiment of FIG. 7, the wing nut 79 is rotated to disengage the bolt 78 from the lower end 65 of the mounting bracket 60. Once the lower filter cover fastener is removed, the lower filter cover 56 and the resilient support member, i.e., spring 64 are lifted vertically off of the filter body 52. The filter body 52 is then lifted off the upper filter cover 54 for cleaning or replacement.

Installing the filter body 52 requires reversing the removal steps described above. Specifically, the top end 53 of the filter body 52 is seated on the exposed surface of the upper filter cover 54. The lower filter cover 56 with the resilient support member, i.e., spring 64 is placed over the filter body 52 such that the resilient support member 64 is slidably inserted within the interior of the filter body 52 in which the intermediate portion 69 of the spring 64 is positioned against the underside of the upper filter gasket 59. The bottom surface of the lower filter cover 56 is lowered and seated against the bottom end lower filter gasket 59. The lower filter cover fastener is then engaged to secure and seal the filter body 52 between the upper and lower filter covers 54 56. For example, in the embodiment of FIG. 1, the wing nut 79 is threaded onto the bolt 78 extending from the bottom surface of the pump housing 71. Alternatively, in the embodiment of FIG. 7, the wing nut 79 is rotated to thread the bolt 78 into the bore 73 extending through the lower end 65 of the mounting bracket 60. The housing cover 12 with the clean or new filter body 52 installed thereon is then flipped over, positioned over and lowered onto the base 14, where it secured thereto by the one or more housing cover fasteners 24.

The self-propelled robotic pool or tank cleaner includes a filter assembly 50 that fixedly suspends a filter body 52 above and spaced apart from the bottom interior surface 27 of the base 14 and the underside surface 25 of the housing cover 12. The positioning of the filter assembly 50 within the interior chamber 26 of the housing 11 permits water drawn through the water inlets to flow from the interior chamber 26, through the filter body 52 and into the interior portion of the filter body 52, where the filtered water is evacuated via the water discharge assembly 30. Debris and other contaminants that are filtered by the filter body 52 are isolated and trapped in an unfiltered zone of the interior chamber formed between interior housing cover walls and the exterior surface of the filter body. As the unfiltered area is larger than the interior or filtered zone of the filter body, large amounts of debris can be collected before maintenance is required to clean the interior of the cleaner and the filter body.

Improper installation and/or alignment of prior art filter bodies in robotic pool cleaners has resulted in debris flowing into the portion of the interior chamber through which only filtered water is supposed to pass, which can undesirably result in recycling the debris back into the pool, as well as damaging the water pump during discharge of the filtered water. To overcome this undesirable deficiency in the prior art, the filter assembly of the present invention is configured to mount to the housing cover by fixedly suspending the filter body below the underside of the housing cover and above the bottom interior surface of the base.

This filter assembly configuration has numerous advantages not seen in the prior art. One advantage is that a user can quickly and easily detach the housing cover along with the filter cartridge assembly to clean or replace the filter body by simply releasing one or several fasteners to access the interior chamber and perform maintenance tasks associated with the filter assembly, such as rinsing out the interior chamber to remove the debris therefrom, and removing and replacing the filter body from the filter assembly. Removal and replacement of the filter body requires only removing a single fastener such as a bolt or wing nut, and removing the lower filter cover to free the filter body and remove it from the filter assembly. After cleaning or replacement, the cleaned or new filter body is seated on the upper filter cover, the lower filter cover is positioned over the filter body, and the fastener is secured to retain the filter body between the upper and lower filter covers, which in turn, secures the filter assembly to the underside of the housing cover. Another advantage is that when the housing cover is positioned over the base for reassembly of the two-part housing, the user does not have to blindly attempt to align the filter with a filter slot or seat formed on the base of the housing. Rather, the user can quickly align the entire periphery of the housing cover over the base and secure it thereto with one or more housing cover fasteners without having to worry about misaligning or improperly seating the filter body.

Yet another advantage of mounting the filter assembly to the housing cover by fixedly suspending the filter body below the underside of the housing cover and above the bottom interior surface of the base is that undesirable noise is reduced, since the bottom portion of the filter assembly does not contact the interior bottom surface of the base. Accordingly, the filter assembly is fixedly positioned and independently suspended within the interior chamber below the interior surface of the housing and freely over the interior surface of the base without any contact and/or support therefrom.

Still another advantage of the filter assembly configuration is that the filter body can have an increased height to maximize surface area and filtering capacity and efficiency. Moreover, the filter height and filtering efficiency is not diminished for a cleaner embodiment that includes a water pump in its internal chamber. Specifically, the filter assembly configuration allows for the water pump to coincide and be suspended within the interior of the filter body in a coaxial arrangement. The coaxial arrangement does not reduce the external filtering surface area or the debris “capture” region in the interior chamber of the housing.

Another advantage is that the mounting bracket enables a user to quickly disassemble and assemble the self-propelled robotic cleaner during maintenance. The mounting bracket also serves as a shock absorber to diminish and/or relieve structural stresses that may occur from activation of the water pump.

While the foregoing is directed to embodiments of the present invention, other and further embodiments and advantages of the invention can be devised by those of ordinary skill in the art based on this description without departing from the basic scope of the invention, which is determined by the claims that follow.

We claim:

1. A self-propelled robotic cleaning apparatus for cleaning a submerged surface of a pool or tank comprising:
a housing having a cover and a base, the base having an interior surface defining at least one water inlet, the housing cover removably fastened to the base to define an interior chamber;
rotationally-mounted supports coupled to the housing for moving the apparatus over the submerged surface of the pool or tank;
a water discharge assembly coupled to an interior surface of the housing cover and having a discharge outlet for recirculating filtered water into the pool or tank;
a filter assembly positioned within the interior chamber for filtering water and debris flowing from the pool or tank through the at least one water inlet, the filter assembly including a filter body having top end and a bottom end; and
a mounting bracket coupled to the water discharge assembly and configured to fixedly position and independently suspend the filter assembly within the interior chamber below the interior surface of the housing cover and above the interior surface of the base.

2. The apparatus of claim 1, wherein the mounting bracket extends from a lower end of the water discharge assembly.

3. The apparatus of claim 2, wherein the mounting bracket is mounted to an outwardly extending flange formed at the lower end of the water discharge assembly.

4. The apparatus of claim 1, wherein the mounting bracket includes an upper filter cover configured to receive and sealingly contact the periphery of the top end of the filter body.

5. The apparatus of claim 1, wherein the filter assembly further comprises an upper filter cover configured to receive at least a portion of the top end of the filter body in sealing contact.

6. The apparatus of claim 5, wherein the upper filter cover is configured to circumscribe a lower end of the water discharge assembly.

7. The apparatus of claim 1, wherein the water discharge assembly comprises a directional water jet propulsion valve assembly mounted to the interior surface of the housing cover.

8. The apparatus of claim 1 wherein the water discharge assembly comprises a discharge conduit extending upwardly and mounted to the interior surface of the housing cover.

9. The apparatus of claim 1, further comprising a lower filter cover positioned adjacent the bottom end of the filter body, wherein the lower filter cover of the filter assembly is configured to sealingly receive at least a portion of the bottom end of the filter body and the filter body is secured between the upper and lower filter covers.

10. The apparatus of claim 9, wherein the lower filter cover is releasably coupled to the mounting bracket.

11. The apparatus of claim 1 further comprising means to generate a low pressure environment in the interior chamber to draw water and debris from the pool or tank through the at least one water inlet for filtering and discharging filtered water through the discharge assembly.

12. The apparatus of claim 11, wherein the means to generate a low pressure environment is a water pump positioned externally from the apparatus and in fluid communication with the discharge outlet via a buoyant flexible conduit.

13. The apparatus of claim 11, wherein the means to generate the low pressure environment is a water pump attached to the mounting bracket, wherein the water pump is suspended within the interior chamber below the interior surface of the housing cover and above an interior surface of the base.

14. The apparatus of claim 13, wherein the filter body is axially aligned with and circumscribes the water pump:

15. The apparatus of claim 13, further comprising a lower filter cover positioned adjacent the bottom end of the filter body, wherein the lower filter cover is positioned below and secured to the water pump.

16. The apparatus of claim 15, wherein the lower filter cover is secured to the water pump with a fastener.

17. The apparatus of claim 1, wherein the filter body is cylindrical.

18. The apparatus of claim 15, wherein the filter assembly further comprises a resilient curvilinear member positioned within an interior portion of the filter body and extending between the bottom and top ends of the filter body, the resilient member conforming to the interior surface of the wall of the filter body.

19. The apparatus of claim 18, wherein the resilient member contacts and supports the interior of the filter body during operation of the water pump.

20. The apparatus of claim 1, wherein top end and the bottom end of the filter body each include a gasket.

21. A self-propelled robotic cleaning apparatus for cleaning a submerged surface of a pool or tank comprising:
a housing having a cover and a base with at least one water inlet, the housing cover removably fastened to the base to define an interior chamber;
rotationally-mounted supports coupled to the housing for moving the apparatus over the submerged surface of the pool or tank;
a water discharge assembly coupled to an interior surface of the housing cover and having a discharge outlet for recirculating filtered water into the pool or tank;
a mounting bracket coupled to a lower portion of the water discharge assembly;
a water pump mounted to the mounting bracket for drawing water and debris from the pool or tank through the at least one water inlet, the water pump being suspended within the interior chamber below the interior surface of the housing cover and above an interior surface of the base; and
a filter assembly circumscribing the water pump for filtering the water and debris drawn into the interior chamber, the filter assembly being fixedly positioned and suspended below the interior surface of the housing cover and above an interior surface of the base.

22. The apparatus of claim 21, wherein the filter assembly further includes a filter body having top end and a bottom end, an upper filter cover positioned adjacent the top end of the filter body and a lower filter cover positioned adjacent the bottom end of the filter body.

23. The apparatus of claim 22, wherein the upper filter cover is mounted to the mounting bracket and the lower filter cover is removably secured to a lower portion of the water pump.

24. The apparatus of claim 23, wherein the water discharge assembly is a water jet valve assembly for discharging a directional water jet to propel the apparatus in a predetermined direction, the water pump being vertically aligned with the water jet valve assembly and including a propeller that is rotatable by an electric motor via a rotatable shaft, the propeller being positioned within a lower portion of the water jet valve assembly.
